(19) United States
(12) Patent Application Publication
(10) Pub. No.: US 2023/0405900 A1
(43) Pub. Date: Dec. 21, 2023

(54) MOLD-CLAMPING DEVICE FOR INJECTION MOLDING MACHINE

(71) Applicant: FANUC CORPORATION, Minamitsuru-gun (JP)

(72) Inventor: Masatoshi SENGA, Minamitsuru-gun, Yamanashi-ken (JP)

(21) Appl. No.: 18/035,209

(22) PCT Filed: Nov. 4, 2021
(86) PCT No.: PCT/JP2021/040481

§ 371 Date: May 3, 2023

(30) Foreign Application Priority Data
Nov. 10, 2020 (JP) 2020-187207

(51) Int. Cl. B29C 45/66

(52) U.S. Cl. CPC B29C 45/661

(57) ABSTRACT

This mold-clamping device, which is for an injection molding machine in which resin in injected into a cavity of an open mold, after which the mold is closed to carry out molding, is provided with a movable platen capable of moving along an axial direction of tie bars, and a parallelism maintenance mechanism for maintaining parallelism between a fixed mold and a movable mold when the resin is injected. The parallelism maintenance mechanism includes a contraction member which has a spring member and is for generating biasing force causing the fixed mold and the movable mold to separate from each other, and a length adjustment member for adjusting the biasing force generated by the contraction member.

### TECHNICAL FIELD

The present invention relates to a mold clamping device of an injection molding machine.

### BACKGROUND ART

An injection molding machine performs molding by injecting a resin material into a cavity of a mold (a fixed mold and a movable mold). For example, when a thin member or a member required to have high dimensional accuracy is molded, injection compression molding is performed (see JP 2000-229343 A). In the injection compression molding, a resin material is injected into an open mold, and then the mold is closed to compress the resin in a cavity.

### SUMMARY OF THE INVENTION

In the injection compression molding, since the mold is not closed at the time of injection, the parallelism between the fixed mold and the movable mold is a problem. When injection is performed in a state where the fixed mold and the movable mold are not kept parallel to each other, and then the mold is closed, the thickness of the molded article tends to become non-uniform. As a result, there is a possibility that the molded article will be defective.

An object of the present invention is to provide a mold clamping device of an injection molding machine that is capable of maintaining the parallelism between a fixed mold and a movable mold with a simple configuration.

According to an aspect of the present invention, there is provided a mold clamping device of an injection molding machine that molds a molded article by injecting resin into a cavity formed in a state where a fixed mold and a movable mold are separated from each other, and moving the movable mold in a closing direction to compress the cavity after the resin is injected, the mold clamping device comprising: a stationary platen configured to hold the fixed mold; a rear platen; a plurality of tie bars configured to connect the stationary platen and the rear platen; a movable platen disposed between the stationary platen and the rear platen, and configured to hold the movable mold in a manner so that the fixed mold and the movable mold face each other, the movable platen being movable along an axial direction of each of the tie bars; and at least three parallelism maintaining mechanisms provided between the stationary platen and the movable platen, and configured to maintain parallelism between the fixed mold and the movable mold at least when the resin is injected into the cavity. Each of the at least three parallelism maintaining mechanisms includes: a contraction member including a spring member and configured to contract in the axial direction to generate a biasing force for separating the fixed mold and the movable mold from each other at least when the resin is injected into the cavity; and a length adjustment member whose length in the axial direction is adjustable to adjust the biasing force generated in the contraction member at least when the resin is injected into the cavity.

According to the present invention, it is possible to maintaining the parallelism between the fixed mold and the movable mold by using a simple configuration.

### BRIEF DESCRIPTION OF DRAWINGS

FIG. 1 is a diagram showing a mold clamping device of an injection molding machine according to an embodiment, and shows the mold clamping device in a state where a mold is completely opened;

FIG. 2 is a diagram showing the mold clamping device of the injection molding machine according to the embodiment, and shows the mold clamping device when resin is injected into the mold 14 in a slightly opened state;

FIG. 3 is a diagram showing a positional relationship between tie bars and four parallelism maintaining mechanisms shown in FIG. 1;

FIG. 4 is a diagram showing a specific configuration of the parallelism maintaining mechanism shown in FIG. 1;

FIG. 5 is a flowchart showing a procedure of injection compression molding using the mold clamping device of the injection molding machine according to the embodiment; and

FIG. 6 is a diagram showing a parallelism maintaining mechanism according to a second modification.

### DETAILED DESCRIPTION OF THE INVENTION

Hereinafter, a mold clamping device of an injection molding machine according to an embodiment of the present invention will be described in detail.

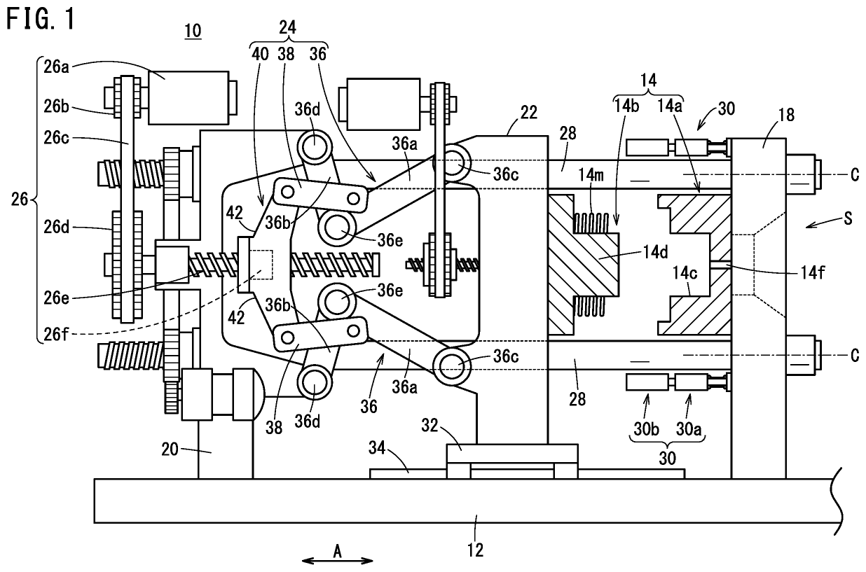

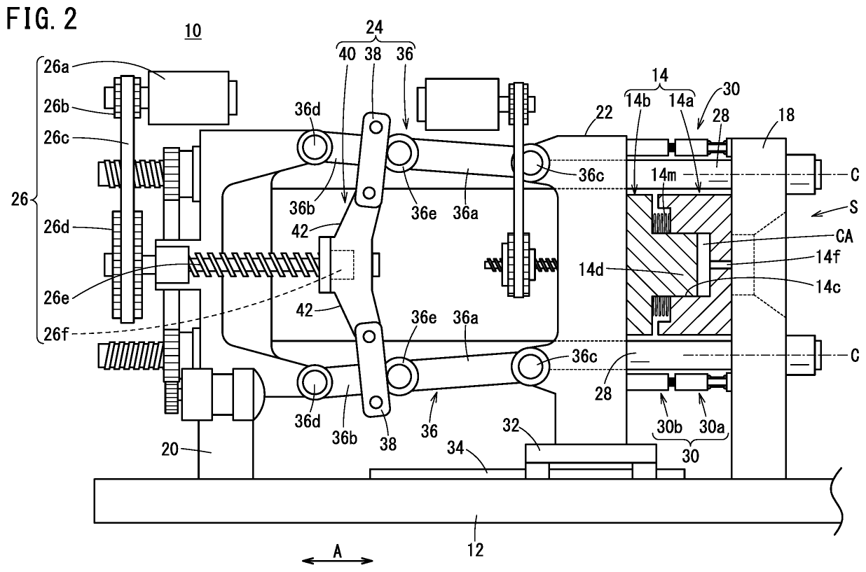

FIGS. 1 and 2 are diagrams showing a mold clamping device 10 of an injection molding machine according to the present embodiment. The mold clamping device 10 is provided on a base 12. The mold clamping device 10 is a device for opening and closing a mold 14. The injection molding machine includes an injection device (not shown). The injection device is provided on the base 12 and injects melted resin into the mold 14. The injection molding machine injects the resin into a cavity CA formed in the mold 14 in a slightly opened state (see FIG. 2). After the resin is injected, the injection molding machine closes the mold 14 to compress the cavity CA. As a result, a molded article made of resin is formed. FIG. 1 shows the mold clamping device 10 in a state where the mold 14 is completely opened. Further, FIG. 2 shows the mold clamping device 10 when the resin is injected into the mold 14 in a slightly opened state.

The base 12 serves as a base for installing the mold clamping device 10 and the injection device thereon. The mold clamping device 10 includes a stationary platen 18, a rear platen 20, a movable platen 22, a toggle mechanism 24, and a mold opening/closing mechanism 26.

The stationary platen 18 and the rear platen 20 are disposed on the base 12. The stationary platen 18 and the rear platen 20 are connected to each other by four tie bars 28 that pass through the movable platen 22. The four tie bars 28 extend parallel to each other in an axial direction A. The axial direction A is parallel to an axis C of the tie bar 28. The movable platen 22 is installed on the base 12 via a slide portion 32, between the stationary platen 18 and the rear platen 20. The slide portion 32 can move along a guide rail 34 provided on the base 12 and extending in the axial direction A. Thus, the movable platen 22 can move forward and backward in the axial direction A with respect to the stationary platen 18 and the rear platen 20.

The mold 14 includes a fixed mold 14a and a movable mold 14b facing each other. The fixed mold 14a is attached to the surface of the stationary platen 18 that faces the movable platen 22. The movable mold 14b is attached to the surface of the movable platen 22 that faces the stationary platen 18.

The fixed mold 14a and the movable mold 14b include a recessed portion 14c and a protruding portion 14d, respectively, which are slidable with respect to each other in the axial direction A. The movable mold 14b is brought close to the fixed mold 14a, and the protruding portion 14d of the movable mold 14b is inserted into the recessed portion 14c of the fixed mold 14a. As a result, the cavity CA is formed between the recessed portion 14c and the protruding portion 14d (see FIG. 2). In FIG. 2, the mold 14 is slightly opened. Therefore, the volume of the cavity CA in the mold 14 of FIG. 2 is larger than the volume of the cavity CA in the mold 14 in a completely closed state.

A flow path 14f is formed in the fixed mold 14a. The flow path 14f serves as a flow path for injecting the resin into the cavity CA along the axial direction A from the outside of the mold 14. The flow path 14f prevents non-uniform parallelism of the mold 14 from occurring due to the injection of the resin. For example, the opening of the flow path 14f is disposed at the bottom portion of the fixed mold 14a, in particular, at the center of the cavity CA when viewed from the axial direction A. As a result, the resin flows from the center to the periphery of the cavity CA, and the parallelism of the mold 14 can be maintained to some extent.

A mold spring member 14m is provided between the fixed mold 14a and the movable mold 14b. The mold spring member 14m biases the movable mold 14b so that the movable mold 14b moves toward the fixed mold 14a. The mold spring member 14m restricts excessive expansion of the cavity CA due to the pressure of the resin injected into the cavity CA.

The mold 14 and four parallelism maintaining mechanisms 30 are provided between the stationary platen 18 and the movable platen 22. The four parallelism maintaining mechanisms 30 are attached to the surface of the stationary platen 18 that faces the movable platen 22, with bolts or the like. The four parallelism maintaining mechanisms 30 are mechanisms for maintaining the parallelism between the fixed mold 14a and the movable mold 14b when the resin is injected into the mold 14. The four parallelism maintaining mechanisms 30 maintain the parallelism between the fixed mold 14a and the movable mold 14b at least at the time of injection into the cavity CA in a state where the fixed mold 14a and the movable mold 14b are slightly separated from each other (the state shown in FIG. 2). The parallelism maintaining mechanisms 30 will be described in detail later.

The toggle mechanism 24 is provided between the rear platen 20 and the movable platen 22. The toggle mechanism 24 is driven by the mold opening/closing mechanism 26. The toggle mechanism 24 opens and closes the mold 14 in the axial direction A (an opening/closing direction) by moving the movable platen 22 forward and backward with respect to the stationary platen 18. The toggle mechanism 24 amplifies the driving force of the mold opening/closing mechanism 26 and transmits the amplified driving force to the movable platen 22.

The toggle mechanism 24 includes toggle links 36, cross links 38, and a crosshead 40. Two toggle links 36 and two cross links 38 are provided on the upper side. Two toggle links 36 and two cross links 38 are also provided on the lower side. That is, a total of four toggle links 36 and a total of four cross links 38 are provided. Here, two toggle links 36 and two cross links 38 are shown on the upper and lower sides of the front side of the plane of the figure. Two toggle links 36 and two cross links 38 on the back side of the plane of the figure are hidden. Each of the toggle links 36 includes a first link rod 36a, a second link rod 36b, a first toggle pin 36c, a second toggle pin 36d, and a third toggle pin 36e.

One end of the first link rod 36a is pivotably connected to the movable platen 22 through the first toggle pin 36c. One end of the second link rod 36b is pivotably connected to the rear platen 20 through the second toggle pin 36d. The other end of the first link rod 36a and the other end of the second link rod 36b are pivotably connected to each other through the third toggle pin 36e.

The second link rods 36b are each connected to the crosshead 40 through the cross link 38. The crosshead 40 includes arms 42 that extend upward and downward, respectively. The cross link 38 is connected to the tip portion of the arm 42.

The mold opening/closing mechanism 26 drives the toggle mechanism 24 to open and close the mold 14 in the axial direction A (the opening/closing direction). The mold opening/closing mechanism 26 includes a mold opening/closing motor 26a (drive source), a drive pulley 26b, a belt 26c, a driven pulley 26d, a ball screw 26e, and a ball screw nut 26f. The ball screw 26e is provided along the axial direction A so as to be parallel with the tie bars 28.

The drive pulley 26b is rotatable integrally with the rotary shaft of the mold opening/closing motor 26a. The driven pulley 26d is rotatable integrally with the ball screw 26e. The belt 26c is wound around the drive pulley 26b and the driven pulley 26d. The belt 26c transmits the rotational force of the drive pulley 26b to the driven pulley 26d. The ball screw 26e is provided on the rear platen 20 so as not to be movable in the axial direction but to be rotatable about the axis. The driven pulley 26d is rotatable integrally with one end portion of the ball screw 26e. The ball screw nut 26f is fixed to the crosshead 40 and is screwed with the ball screw 26e. The ball screw nut 26f and the crosshead 40 move along the ball screw 26e in accordance with rotation of the ball screw 26e.

In this case, the rotational force of the mold opening/closing motor 26a is transmitted to the ball screw 26e via the drive pulley 26b, the belt 26c, and the driven pulley 26d. As a result, the ball screw 26e rotates. Thus, the ball screw nut 26f and the crosshead 40 move in the axial direction A along the ball screw 26e. The driving force of the crosshead 40 in the axial direction A is transmitted to the movable platen 22 via the cross links 38 and the toggle links 36. As a result, the movable platen 22 moves along the axial direction A.

When the movable platen 22 moves toward the rear platen 20, the movable mold 14b moves away from the fixed mold 14a as shown in FIG. 1. That is, the mold 14 is opened. When the movable platen 22 moves toward the stationary platen 18, the movable mold 14b comes into contact with the fixed mold 14a. That is, the mold 14 is closed. As described above, FIG. 2 shows the mold 14 in a slightly opened state before the mold 14 is completely closed.

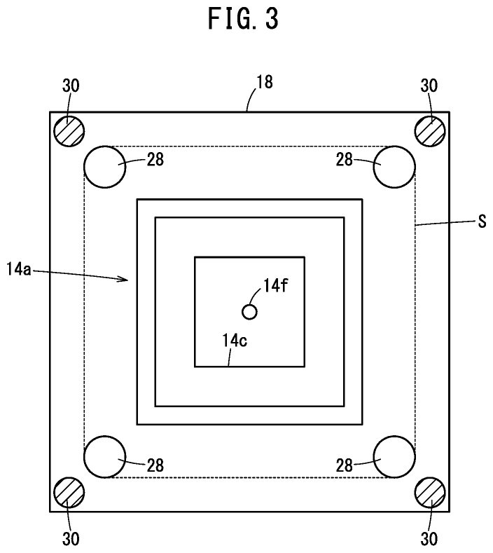

FIG. 3 is a diagram showing a positional relationship between the tie bars 28 and the four parallelism maintaining mechanisms 30 shown in FIG. 1. Here, the positional relationship between the tie bars 28 and the parallelism maintaining mechanisms 30 when the stationary platen 18 is viewed from the movable platen 22 is shown. The four tie bars 28 form a substantially rectangular parallelepiped space S surrounding the mold 14 (the fixed mold 14a and the movable mold 14b). The four parallelism maintaining mechanisms 30 are disposed outside the space S. More specifically, the four parallelism maintaining mechanisms 30 are disposed along the outer peripheries of the four tie bars 28, respectively. This prevents the parallelism maintaining mechanisms 30 from interfering with the attachment of the mold 14 to the stationary platen 18 and the movable platen 22.

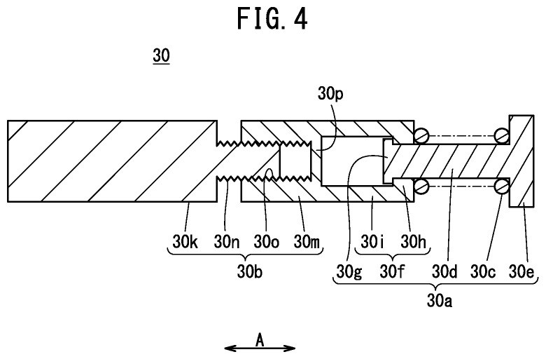

FIG. 4 is a diagram showing a specific configuration of the parallelism maintaining mechanism 30 shown in FIG. 1. The parallelism maintaining mechanism 30 includes a contraction member 30a and a length adjustment member 30b. The parallelism maintaining mechanism 30 is attached to the stationary platen 18 with bolts or the like.

The contraction member 30a includes a spring member 30c and is contractible in the axial direction A. The contraction member 30a includes a shaft portion 30d, a fixing member 30e, a slide member 30f, and a spring member 30c. The shaft portion 30d extends along the axial direction A. The fixing member 30e is fixed to the shaft portion 30d. The slide member 30f is slidable with respect to the shaft portion 30d. The spring member 30c is disposed between the fixing member 30e and the slide member 30f. The fixing member 30e is fixed to one end of the shaft portion 30d. A locking portion 30g having a larger diameter than the shaft portion 30d is provided at the other end of the shaft portion 30d. The slide member 30f includes a plate-shaped member 30h and a tubular member 30i. The plate-shaped member 30h includes a through hole through which the shaft portion 30d passes. The tubular member 30i is fixed to the plate-shaped member 30h and accommodates the locking portion 30g. The locking portion 30g is movably disposed inside the tubular member 30i. The locking portion 30g is movable leftward in FIG. 4 with respect to the plate-shaped member 30h from a state where the locking portion 30g is in contact with the plate-shaped member 30h. The contraction member 30a contracts in the axial direction A in accordance with the leftward movement of the locking portion 30g.

The length of the length adjustment member 30b in the axial direction A is adjustable. The length adjustment member 30b includes a first member 30k and a second member 30m. The first member 30k extends along the axial direction A. The second member 30m extends along the axial direction A and is screwed with the first member 30k. The first member 30k includes an external threaded portion 30n, and the second member 30m includes an internal threaded portion 30o (screw hole) that is screwed with the external threaded portion 30n. Note that the first member 30k may include the internal threaded portion 30o, and the second member 30m may include the external threaded portion 30n. By relative rotation between the first member 30k and the second member 30m, the length of the length adjustment member 30b in the axial direction A can be adjusted.

In the present embodiment, the parallelism maintaining mechanism 30 is a rod-shaped member including the contraction member 30a and the length adjustment member 30b. That is, the contraction member 30a and the length adjustment member 30b are connected to each other along the axial direction A to form the rod-shaped member. Specifically, the slide member 30f of the contraction member 30a and the second member 30m of the length adjustment member 30b are connected to each other. Here, a partition wall 30p is disposed at the boundary between the slide member 30f and the second member 30m. However, the partition wall 30p may be omitted.

As described above, in the present embodiment, the resin is injected into the cavity CA formed in the mold 14 in a slightly opened state (see FIG. 2). The position of the movable mold 14b shown in FIG. 2 is defined as an injection position.

Here, the length of each of the four parallelism maintaining mechanisms 30 in the axial direction A is greater than the distance between the fixed mold 14a and the movable mold 14b that is at the injection position. Therefore, when the movable mold 14b reaches the injection position, the contraction member 30a (the spring member 30c) of each of the four parallelism maintaining mechanisms 30 contracts. As a result, a force (biasing force) for opening the mold 14 is generated in the contraction member 30a. That is, at least when the resin is injected into the cavity CA, the contraction member 30a contracts to generate a biasing force for separating the fixed mold 14a and the movable mold 14b from each other. Here, in order to adjust the biasing force generated in the contraction member 30a, the length of the length adjustment member 30b in the axial direction A is adjustable. That is, by changing the length of each of the four parallelism maintaining mechanisms 30, the biasing force generated in each of the four parallelism maintaining mechanisms 30 can be adjusted. Therefore, by adjusting the length of the length adjustment member 30b of each of the parallelism maintaining mechanisms 30, the parallelism of the mold 14 (the fixed mold 14a and the movable mold 14b) can be maintained at least at the time of injection.

It should be noted that a plurality of the parallelism maintaining mechanisms 30 may be adjusted in advance correspondingly to a plurality of the molds 14, respectively, and then the parallelism maintaining mechanisms 30 may be exchanged in accordance with the mold 14. As a result, it is possible to omit the measurement of the parallelism and the adjustment of the parallelism maintaining mechanisms 30 immediately before the injection.

### (Injection Compression Molding Using Mold Clamping Device 10 of Injection Molding Machine)

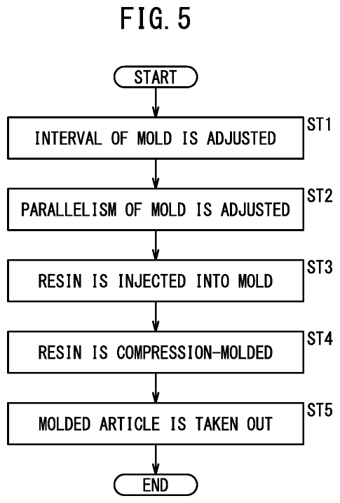

By using the mold clamping device 10 of the injection molding machine, injection compression molding can be performed in a state where the parallelism of the mold 14 is maintained as follows. FIG. 5 is a flowchart showing a procedure of injection compression molding using the mold clamping device 10 of the injection molding machine according to the present embodiment. The procedure of the injection compression molding will be described below with reference to FIG. 5.

The interval in the mold 14 (between the fixed mold 14a and the movable mold 14b) is adjusted (step ST1). That is, the movable mold 14b is brought close to the fixed mold 14a and moved to the injection position (see FIG. 2). Thereafter, prior to injection of the resin, the parallelism of the mold 14 (the fixed mold 14a and the movable mold 14b) is adjusted by using the parallelism maintaining mechanisms 30 (step ST2). That is, the parallelism of the mold 14 when the movable mold 14b is at the injection position is measured. Specifically, the distribution of the interval between the fixed mold 14a and the movable mold 14b is measured. Based on the measurement result, the lengths of the four length adjustment members 30b are adjusted to achieve the uniform parallelism of the mold 14.

Specifically, the length of the length adjustment member 30b is increased at a location where the interval between the fixed mold 14a and the movable mold 14b is narrow. As a result, the biasing force generated in the contraction member 30a increases. Thus, the interval (that is, parallelism) between the fixed mold 14a and the movable mold 14b can be made uniform. That is, the parallelism between the fixed mold 14a and the movable mold 14b can be maintained without changing the setting of the mold clamping device 10 itself (for example, the state of the mold opening/closing mechanism 26).

After the parallelism is maintained, the resin is injected into the cavity CA of the mold 14 (step ST3). That is, the resin is injected into the cavity CA in a state where the parallelism of the mold 14 is ensured.

Note that the adjustment of the parallelism maintaining mechanisms 30 and the injection of the resin may not be performed continuously. For example, a plurality of the parallelism maintaining mechanisms 30 may be adjusted in advance correspondingly to a plurality of the molds 14, respectively, and then the parallelism maintaining mechanisms 30 may be exchanged in accordance with the mold 14. That is, the mold 14 and the parallelism maintaining mechanisms 30 adjusted correspondingly to this mold 14 are once detached from the mold clamping device 10, and then attached again to perform injection.

The resin is compression-molded (step ST4). Specifically, after the resin is injected, the movable mold 14b is moved in the closing direction to compress the cavity CA. As a result, a molded article is formed. In this case, with the compression of the cavity CA, the mold 14 is completely closed. In this manner, the resin is injected in a state where the parallelism of the mold 14 is maintained, and then the cavity CA is compressed. Therefore, the uniformity of the thickness of the resin in the cavity CA (ultimately, the uniformity of the molded article) is ensured.

After the molding is completed, the movable mold 14b is moved in the opening direction to separate the movable mold 14b from the fixed mold 14a, and then the molded article is taken out (step ST5).

### (Modification 1)

A first modification will be described. In the first modification, the parallelism maintaining mechanisms 30 are provided not on the stationary platen 18 but on the movable platen 22. In this case, the parallelism maintaining mechanisms are attached to the movable platen 22 with bolts or the like.

### (Modification 2)

As described above, the parallelism maintaining mechanism of the present embodiment is a rod-shaped member in which the contraction member 30a and the length adjustment member 30b are connected to each other along the axial direction A. On the other hand, the contraction member 30a and the length adjustment member 30b of the parallelism maintaining mechanism 30 may be separate members that are not connected to each other.

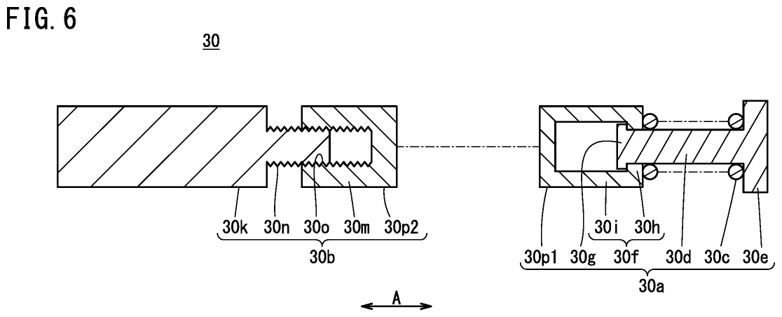

FIG. 6 is a diagram showing the parallelism maintaining mechanism 30 according to a second modification. In this instance, the tubular member 30i of the contraction member 30a and the second member 30m of the length adjustment member 30b are separate members that are separated from each other. Here, the end portion of the tubular member 30i and the end portion of the second member 30m face each other, and include a cover portion 30p1 and a cover portion 30p2, respectively. However, the cover portion 30p1 and the cover portion 30p2 may not be provided.

The contraction member 30a is attached to one of the stationary platen 18 or the movable platen 22. The length adjustment member 30b is attached to the other of the stationary platen 18 and the movable platen 22. For example, bolts are used for the attachment. In this case, the contraction member 30a and the length adjustment member 30b are arranged on the same axis along the axial direction A. When the movable mold 14b is brought close to the fixed mold 14a and disposed at the injection position, the second member 30m of the length adjustment member 30b and the tubular member 30i of the contraction member 30a come into contact with each other. As a result, the length adjustment member 30b presses the contraction member 30a, and a biasing force is generated in the contraction member 30a.

### (Other Modifications)

In the present embodiment and the first and second modifications, the number of the parallelism maintaining mechanisms 30 may be three, or five or more. The present invention is not limited to the above-described embodiment, and various configurations can be adopted therein without departing from the essence and gist of the present invention.

[Invention Obtained from Embodiment and Modifications]

The invention that can be grasped from the above-described embodiment and modifications thereof will be described below.

[1] Provided is the mold clamping device (10) of the injection molding machine that molds a molded article by injecting the resin into the cavity (CA) formed in a state where the fixed mold (14a) and the movable mold (14b) are separated from each other, and moving the movable mold in a closing direction to compress the cavity after the resin is injected, the mold clamping device including: the stationary platen (18) configured to hold the fixed mold; the rear platen (20); the plurality of tie bars (28) configured to connect the stationary platen and the rear platen; the movable platen (22) disposed between the stationary platen and the rear platen, and configured to hold the movable mold in a manner so that the fixed mold and the movable mold face each other, the movable platen being movable along the axial direction (C) of each of the tie bars; and at least three parallelism maintaining mechanisms (30) provided between the stationary platen and the movable platen, and configured to maintain parallelism between the fixed mold and the movable mold at least when the resin is injected into the cavity. Each of the at least three parallelism maintaining mechanisms includes: the contraction member (30a) including the spring member (30c) and configured to contract in the axial direction to generate the biasing force for separating the fixed mold and the movable mold from each other at least when the resin is injected into the cavity; and the length adjustment member (30b) whose length in the axial direction is adjustable to adjust the biasing force generated in the contraction member at least when the resin is injected into the cavity. According to this feature, when the resin is injected (at the time of injection) into the cavity formed in a state where the fixed mold and the movable mold are separated from each other, the parallelism between the fixed mold and the movable mold can be maintained by the at least three parallelism maintaining mechanisms, and the uniformity of the resin in the cavity can be maintained.

[2] Each of the at least three parallelism maintaining mechanisms is a rod-shaped member (the parallelism maintaining mechanism 30) in which the contraction member and the length adjustment member are connected to each other along the axial direction, and is provided on the stationary platen or the movable platen, and each of the at least three parallelism maintaining mechanisms is pressed by the fixed mold and the movable mold to generate the biasing force in the contraction member at least when the resin is injected into the cavity. According to this feature, the parallelism between the fixed mold and the movable mold can be maintained at the time of injection by using the at least three parallelism maintaining mechanisms provided on the stationary platen or the movable platen.

[3] The contraction member is provided on one of the stationary platen or the movable platen, the length adjustment member is provided on another one of the stationary platen or the movable platen, and each of the at least three parallelism maintaining mechanisms is configured in a manner so that the length adjustment member presses the contraction member to generate the biasing force in the contraction member at least when the resin is injected into the cavity. According to this feature, the parallelism between the fixed mold and the movable mold can be maintained at the time of injection by using the contraction member and the length adjustment member provided on the stationary platen and the movable platen, respectively.

[4] The length adjustment member includes the first member (30k) extending along the axial direction, and the second member (30m) extending along the axial direction and configured to be screwed with the first member. According to this feature, the length of the length adjustment member in the axial direction can be adjusted by rotating the first member and the second member relative to each other.

[5] The contraction member includes the shaft portion (30d) extending along the axial direction, the fixing member (30e) fixed to the shaft portion, the slide member (30f) slidable with respect to the shaft portion, and the spring member disposed between the fixing member and the slide member. According to this feature, at the time of injection, the spring member contracts in the axial direction to generate the biasing force for separating the fixed mold and the movable mold from each other.

1. A mold clamping device of an injection molding machine that molds a molded article by injecting resin into a cavity formed in a state where a fixed mold and a movable mold are separated from each other, and moving the movable mold in a closing direction to compress the cavity after the resin is injected, the mold clamping device comprising:
a stationary platen configured to hold the fixed mold;
a rear platen;
a plurality of tie bars configured to connect the stationary platen and the rear platen;
a movable platen disposed between the stationary platen and the rear platen, and configured to hold the movable mold in a manner so that the fixed mold and the movable mold face each other, the movable platen being movable along an axial direction of each of the tie bars; and
at least three parallelism maintaining mechanisms provided between the stationary platen and the movable platen, and configured to maintain parallelism between the fixed mold and the movable mold at least when the resin is injected into the cavity,
wherein each of the at least three parallelism maintaining mechanisms includes:
a contraction member including a spring member and configured to contract in the axial direction to generate a biasing force for separating the fixed mold and the movable mold from each other at least when the resin is injected into the cavity; and
a length adjustment member whose length in the axial direction is adjustable to adjust the biasing force generated in the contraction member at least when the resin is injected into the cavity.

2. The mold clamping device of the injection molding machine according to claim 1, wherein
each of the at least three parallelism maintaining mechanisms is a rod-shaped member in which the contraction member and the length adjustment member are connected to each other along the axial direction, and is provided on the stationary platen or the movable platen, and
each of the at least three parallelism maintaining mechanisms is pressed by the fixed mold and the movable mold to generate the biasing force in the contraction member at least when the resin is injected into the cavity.

3. The mold clamping device of the injection molding machine according to claim 1, wherein
the contraction member is provided on one of the stationary platen or the movable platen,
the length adjustment member is provided on another one of the stationary platen or the movable platen, and
each of the at least three parallelism maintaining mechanisms is configured in a manner so that the length adjustment member presses the contraction member to generate the biasing force in the contraction member at least when the resin is injected into the cavity.

4. The mold clamping device of the injection molding machine according to claim 1, wherein
the length adjustment member includes a first member extending along the axial direction, and a second member extending along the axial direction and configured to be screwed with the first member,

5. The mold clamping device of the injection molding machine according to claim 1, wherein
the contraction member includes a shaft portion extending along the axial direction, a fixing member fixed to the shaft portion, a slide member slidable with respect to the shaft portion, and the spring member disposed between the fixing member and the slide member.
